(19) United States
(12) Patent Application Publication
(10) Pub. No.: US 2010/0115471 A1
(43) Pub. Date: May 6, 2010

(54) MULTIDIMENSIONAL WIDGETS

(75) Inventors: John O. Louch, San Luis Obispo, CA (US); Imran A. Chaudhri, San Francisco, CA (US)

Correspondence Address: FISH & RICHARDSON P.C., PO BOX 1022, MINNEAPOLIS, MN, 55440-1022, US

(73) Assignee: APPLE INC., Cupertino, CA (US)

(21) Appl. No.: 12/612,301

(22) Filed: Nov. 4, 2009

Related U.S. Application Data
(60) Provisional application No. 61/111,129, filed on Nov. 4, 2008.

(51) Int. Cl. G06F 3/048

(52) U.S. Cl. 715/849; 715/852

(57) ABSTRACT

Systems, methods, computer-readable mediums, user interfaces and other implementations are disclosed for implementing multidimensional widgets. A multidimensional widget is a three-dimensional object with application surfaces, and each application surface is associated with a widget function. Multidimensional widgets can be modified by adding functions or grouping with other widgets.

### CROSS-REFERENCED TO RELATED APPLICATIONS

This application claims the benefit under 35 U.S.C. §119(e) of U.S. Patent Application No. 61/111,129, titled “MULTIDIMENSIONAL WIDGETS,” filed Nov. 4, 2008, which is incorporated herein by reference.

### TECHNICAL FIELD

The disclosed implementations relate generally to graphical user interfaces.

### BACKGROUND

A hallmark of modern graphical user interfaces is that they allow a large number of graphical objects or items to be displayed on a display screen at the same time. Leading personal computer operating systems, such as Apple Mac OS®, provide user interfaces in which a number of windows can be displayed, overlapped, resized, moved, configured, and reformatted according to the needs of the user or application. Taskbars, menus, virtual buttons and other user interface elements provide mechanisms for accessing and activating windows even when they are hidden behind other windows.

Although users appreciate interfaces that can present information on a screen via multiple windows, the result can be overwhelming. For example, users may find it difficult to navigate to a particular user interface element or to locate a desired element among a large number of onscreen elements. The problem is further compounded when user interfaces allow users to position elements in a desired arrangement, including overlapping, minimizing, maximizing, and the like. Although such flexibility may be useful to the user, it can result in a cluttered display screen. Having too many elements displayed on the screen can lead to “information overload,” thus inhibiting the user to efficiently use the computer equipment.

Many of the deficiencies of conventional user interfaces can be reduced using “widgets.” Generally, widgets are user interface elements that include information and one or more tools (e.g., applications) that let the user perform common tasks and provide fast access to information. Widgets can perform a variety of tasks, including without limitation, communicating with a remote server to provide information to the user (e.g., weather report), providing commonly needed functionality (e.g., a calculator), or acting as an information repository (e.g., a notebook). Widgets can be displayed and accessed through a user interface, such as a “dashboard layer,” which is also referred to as a “dashboard.”

Due to the large number of widgets available to a user, a virtual desktop or dashboard can become cluttered and disorganized, making it difficult for the user to quickly locate and access a widget. Furthermore, each widget may be able to perform a number of different functions, and to access these functions the user must engage an interaction model of the widget, that may require several user selections and user commands, which can become repetitive and degrade the user experience.

### SUMMARY

In general, one aspect of the subject matter described in this specification can be embodied in methods that include defining a viewing surface; modeling a depth axis extending from the viewing surface; generating a plurality of three-dimensional widgets disposed along the depth axis, each three dimensional widget being a three-dimensional representation of an object and having a plurality of application surfaces; and for each three-dimensional widget having a plurality of widget functions, associate the widget functions with corresponding application surfaces. Other embodiments of this aspect include corresponding systems, apparatus, and computer program products.

Another aspect of the subject matter described in this specification can be embodied in methods that include defining a viewing surface; defining a back surface disposed from the viewing surface along a depth axis; and generating a widget receptacle disposed along the depth axis, the widget receptacle and having a plurality of receptacle surfaces, each receptacle surface being associated with a widget and being actuated by a selection of the receptacle surface, and upon such actuation causing an instantiation of the widget associated with the receptacle surface. Other embodiments of this aspect include corresponding systems, apparatus, and computer program products.

The details of one or more embodiments of the subject matter described in this specification are set forth in the accompanying drawings and the description below. Other features, aspects, and advantages of the subject matter will become apparent from the description, the drawings, and the claims.

### BRIEF DESCRIPTION OF DRAWINGS

FIG. 1 is a block diagram of a hardware architecture for implementing dashboards.

FIG. 2 is a flow diagram of a process for activating and using a dashboard.

FIG. 3 is a block diagram of a software architecture for implementing dashboards.

FIG. 4A is a screen shot depicting a desktop user interface prior to activation of a dashboard.

FIG. 4B is a screen shot depicting an initial state for a dashboard.

FIG. 4C is a screen shot depicting a configuration bar for a dashboard with three-dimensional widgets.

FIG. 4D is a screen shot depicting an example display of three-dimensional widgets in a dashboard.

FIG. 4E is a screen shot depicting the grouping of two three-dimensional widgets and conventional widget to generate a widget receptacle.

FIG. 4F is a screen shot depicting various widget receptacles in response to configuring three-dimensional widgets using the configuration bar.

FIG. 4G is a screen shot depicting three-dimensional widgets and a widget receptacle displayed along a depth axis without a perspective angle.

FIG. 5 is a flow diagram of a process for generating and displaying three-dimensional widgets.

FIG. 6 is a flow diagram of a process for generating and displaying a widget receptacle.

### DETAILED DESCRIPTION

### Hardware Architecture

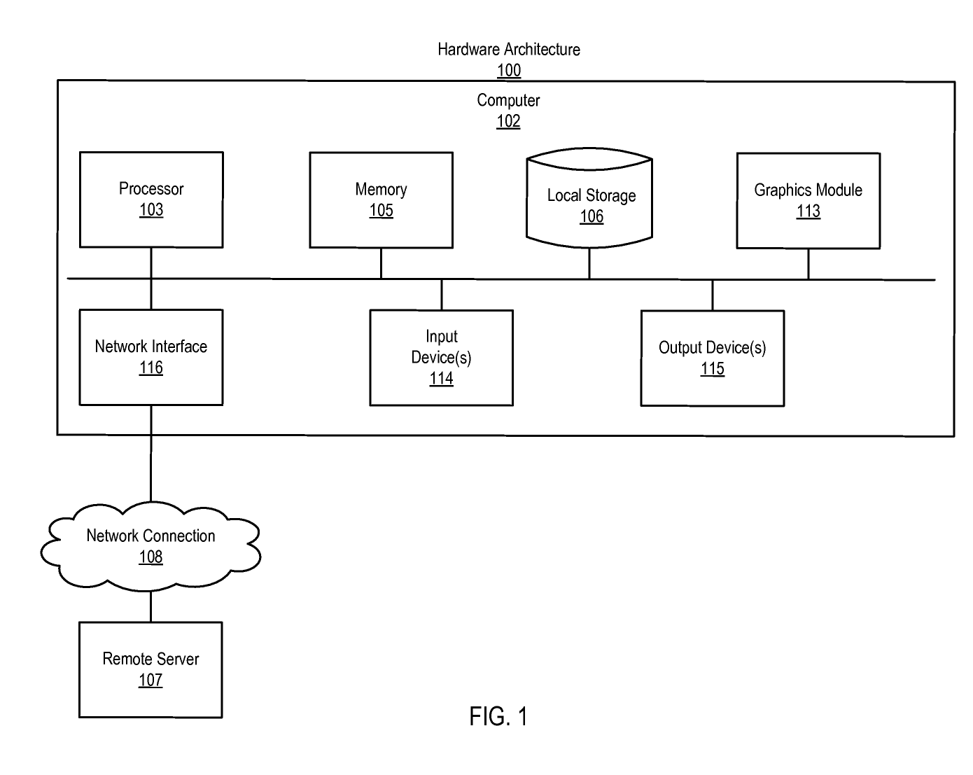

FIG. 1 is a block diagram of a hardware architecture 100 for implementing widgets. The widgets can include conventional two-dimensional widgets and three-dimensional widgets. The architecture 100 includes a personal computer 102 optionally coupled to a remote server 107 via a network interface 116 and a network connection 108 (e.g., local area network, wireless network, Internet, intranet, etc.). The computer 102 generally includes a processor 103, memory 105, one or more input devices 114 (e.g., keyboard, mouse, etc.) and one or more output devices 115 (e.g., a display device). A user interacts with the architecture 100 via the input and output devices 114, 115.

The computer 102 also includes a local storage device 106 and a graphics module 113 (e.g., graphics card) for storing information and generating graphical objects, respectively. The graphics module 113 and the processor can execute an interface engine capable of generating a three-dimensional user interface environment, i.e., an environment having x, y, and z axis camera coordinates. The user interface engine operates at an application level and implements graphical functions and features available through an application program interface (API) layer and supported by the graphics module 113. Example graphical functions and features include graphical processing, supported by a graphics API, image processing, support by an imaging API, and video processing, supported by a video API. The API layer in turn, interfaces with a graphics library. The graphics library is implemented as a software interface to graphics module 113, such as an implementation of the OpenGL specification.

The local storage device 106 can be a computer-readable medium. The term “computer-readable medium” refers to any medium that participates in providing instructions to a processor for execution, including without limitation, non-volatile media (e.g., optical or magnetic disks) and volatile media (e.g., memory).

While three-dimensional widgets are described herein with respect to a personal computer 102, it should be apparent that the disclosed implementations can be incorporated in, or integrated with, any electronic device that is capable of using widgets, including without limitation, portable and desktop computers, servers, electronics, media players, game devices, mobile phones, email devices, personal digital assistants (PDAs), televisions, etc.

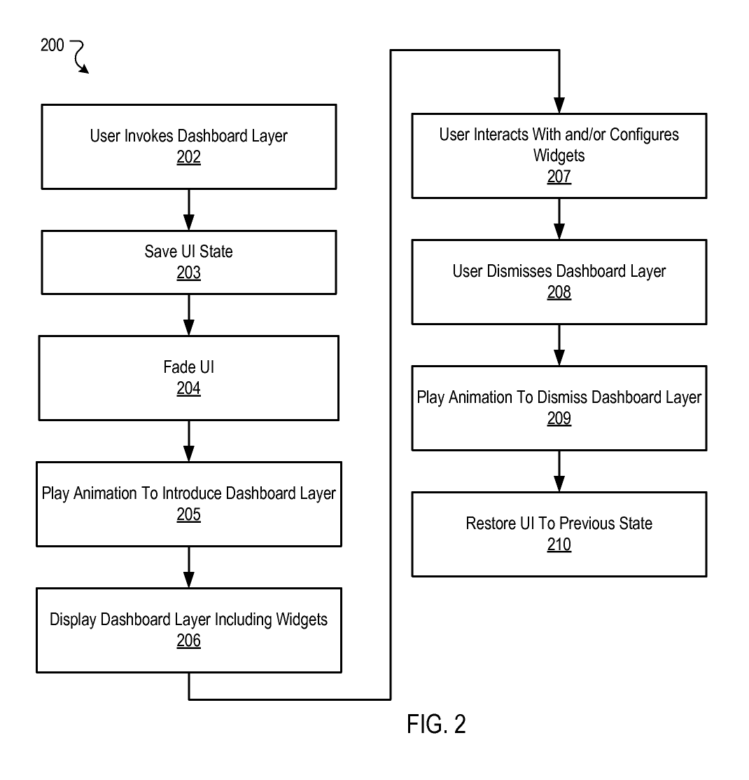

A dashboard system and method for managing and displaying dashboards and three-dimensional widgets can be implemented as one or more plug-ins that are installed and run on the personal computer 102. The plug-ins can be configured to interact with an operating system (e.g., MAC OS® X, WINDOWS XP, LINUX, etc.) and to perform the various dashboard and widget functions, as described with respect of FIGS. 2-6. The dashboard system and method can also be implemented as one or more software applications running on a computer system (e.g., computer 102). In some implementations, a dashboard system can be another widget that is configurable to communicate with other widgets, applications and/or operating systems. The dashboard system and method can also be characterized as a framework or model that can be implemented on various platforms and/or networks (e.g., client/server networks, stand-alone computers, portable electronic devices, mobile phones, etc.), and/or embedded or bundled with one or more software applications (e.g., email, media player, browser, etc.).

For illustrative purposes, widgets (including three-dimensional widgets) are described as a feature of an operating system. Three-dimensional widgets, however, can be implemented in other contexts as well, including e-mail environments, desktop environments, application environments, hand-held display environments, and any other display environments.

### Dashboard Overview

FIG. 2 is a flow diagram of an implementation of a process 200 for activating and using one or more dashboard layers. A dashboard layer (also referred to herein as a “unified interest layer” or “dashboard”) is used to manage and display widgets (including three-dimensional widgets). A user can invoke a dashboard (202) by hitting a designated function key or key combination, or by clicking on an icon, or by selecting a command from an onscreen menu, or by moving an onscreen cursor to a designated corner of the screen. Alternatively, a dashboard layer can be invoked programmatically by another system, such as an application or an operating system, etc.

In response to such invocation, the current state of the user interface is saved (203), the user interface is temporarily inactivated (204), an animation or effect is played or presented to introduce the dashboard (205) and the dashboard is displayed with one or more widgets (206). If applicable, a previous state of the dashboard is retrieved, so that the dashboard can be displayed in its previous configuration.

In some implementations, the dashboard is overlaid on an existing user interface (UI) (e.g., a desktop UI). When the dashboard is activated, the existing UI may be faded, darkened, brightened, blurred, distorted, or otherwise altered to emphasize that it is temporarily inactivated. The existing UI may or may not be visible behind the dashboard. The UI can also be shrunk to a small portion of the display screen while the dashboard is active, and can be re-activated by clicking on it. In some implementations, the UI is shrunk and presented as a widget. The UI can be re-activated by clicking on the widget. In some implementations the UI remains active when the dashboard is active.

The user interacts with and/or configures widgets as desired (207). In some implementations, the user can move three-dimensional widgets anywhere in the x, y and z axes, can rotate the three-dimensional widgets, and can resize the three-dimensional widgets.

Some three-dimensional widgets automatically resize themselves or rotate accordingly based on the amount or nature of the data being displayed. Three-dimensional widgets can overlap and or repel one another. For example, if the user attempts to move one three-dimensional widget to a screen position occupied by another three-dimensional widget, one of the three-dimensional widgets is automatically moved out of the way or repelled by the other widget.

A physics model can be implemented, such as a rigid-body Newtonian physics model, to animate such movement. For example, a user may rotate a first three-dimensional widget so that it makes contact with a second three-dimensional widget displayed nearby. The second three-dimensional widget may, in turn, rotate in response, and/or be repelled due to the modeled force imparted on the second three-dimensional widget.

In some implementations, the user dismisses the dashboard (208) by invoking a dismissal command, which causes the UI layer to return or re-present itself to the display screen. In some implementations, the dashboard is dismissed when the user presses a function key or key combination (which may be the same or different than the key or combination used to activate the dashboard), or clicks on a close box or other icon, or clicks on negative space within the dashboard (e.g., a space between widgets), or moves an onscreen cursor to a predefined corner of the screen. Other dismissal methods are possible.

In some implementations, the dashboard is automatically dismissed (i.e., without user input) after some predetermined period of time or in response to a trigger event. An animation or other effect can be played or presented to provide a transition as the dashboard is dismissed (209). When the dashboard is dismissed, the current configuration or state of the widgets (e.g., position, size, etc.) is stored, so that it can be retrieved the next time the dashboard is activated. In some implementations, an animation or effect is played or presented when re-introducing the UI. The UI is restored to its previous state (210) so that the user can resume interaction with software applications and/or the operating system.

In some implementations, the dashboard is configurable. The user can select a number of widgets to be displayed, for example, by dragging the widgets from a configuration bar (or other user interface element) onto the dashboard. The configuration bar can include different types of widgets, and can be categorized and/or hierarchically organized. In some implementations, in response to the user dragging a widget onto the configuration bar, the widget is downloaded from a server and automatically installed (if not previously installed). In some implementations, certain widgets can be purchased, so the user is requested to provide a credit card number or some other form of payment before the widget is installed on the user's device. In some implementations, widgets are already installed on the user's device, but are only made visible when they have been dragged from the configuration bar onto the dashboard. The configuration bar is merely an example of one type of UI element for configuring the dashboard. Other configuration mechanisms can be used, such as an icon tray or menu system.

It should be apparent that there are many ways in which dashboards and widgets can be displayed other than those implementations described herein. For example, widgets can be displayed on any user interface or user interface element, including but not limited to desktops, browser or application windows, menu systems, trays, multi-touch sensitive displays and other widgets.

### Software Architecture

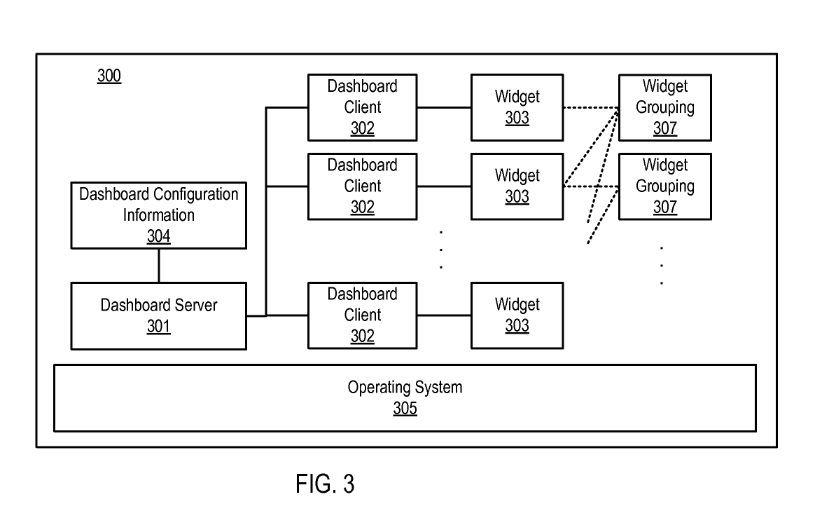

FIG. 3 is a block diagram of a software architecture 300 for implementing dashboards for installing, displaying and launching three-dimensional widgets. The software architecture 300 generally includes a dashboard server 301, one or more dashboard clients 302, one or more widgets 303 (including three-dimensional widgets), and one or more widget groupings 307. The server 301 and/or clients 302 use dashboard configuration information 304 to specify configuration options for displaying the widgets 303 including access levels, linking information and the like (if applicable) and widget groupings. Such configuration information can include information for two or more dashboards configured by the same user or by different users.

In some implementations, the widgets 303 are displayed using a three-dimensional graphics library and are written in any language or script that is supported by the graphics library. The dashboard server 301 manages and launches the dashboard client 302 processes. Each dashboard client 302 loads a widget 303 (e.g., a three-dimensional rendered object) and related resources needed to render the widget 303. In some implementations, the widgets 303 are rendered into the dashboard layer, which is drawn on top of the desktop user interface, so as to partially or completely obscure the desktop user interface while the dashboard layer is active. The dashboard layer can, in three-dimensional space, be a plane that is positioned above the desktop, i.e., a distance along the z-axis above the desktop.

The widgets 303 can be grouped according to one or more widget grouping 307. A widget grouping 307 is an association of two or more widgets 303. Each widget groupings 307 can be associated with predefined categories, such as Food, Games, News, etc., and each widget grouping 307 can include only widgets 303 that belong to the widget grouping's category.

The widget groupings 307 can also be user defined. For example, a user may manually group two widgets 303, regardless of category, to form a widget grouping 307.

The widget groupings 307 can be used to generate and display widget receptacles, which are graphical user interface elements that represent two or more widgets, including three-dimensional widgets, as a single three-dimensional object.

### Dashboard Server

The dashboard server 301 (also referred to as “server”) can be a stand-alone process or embedded in another process. The server 301 can be located at the computer 102 or at the remote server 107. In some implementations, the server 301 provides functionality for one or more processes, including but not limited to: non-widget UI management, window management, fast login, event management, loading widgets, widget arbitration and image integration.

### Dashboard Client

In some implementations, a dashboard client 302 is a process that uses, for example, objects that are defined as part of a development environment, such as Apple Computer's Cocoa Application Framework (also referred to as the Application Kit, or AppKit) for the Mac OS® operating system.

### Widget Format

In one implementation, each three-dimensional widget 303 is implemented using OpenGL programming. OpenGL programming can be readily facilitated using Apple Computer's Cocoa Application Framework. Other graphics libraries and other application development frameworks, however, can be used for other computer systems.

### Dashboard Invocation

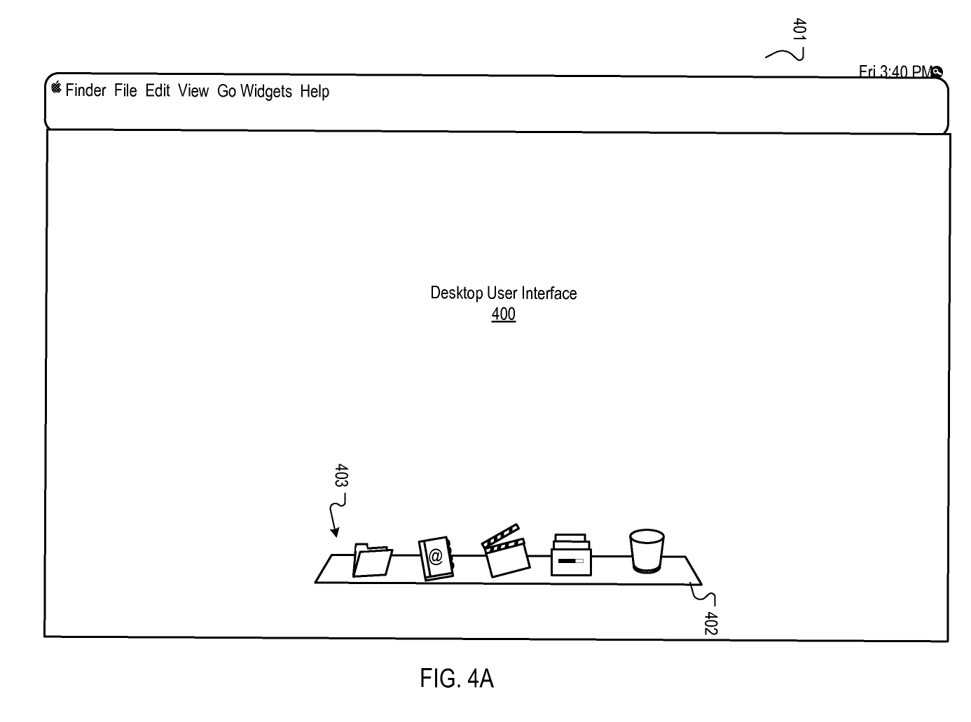

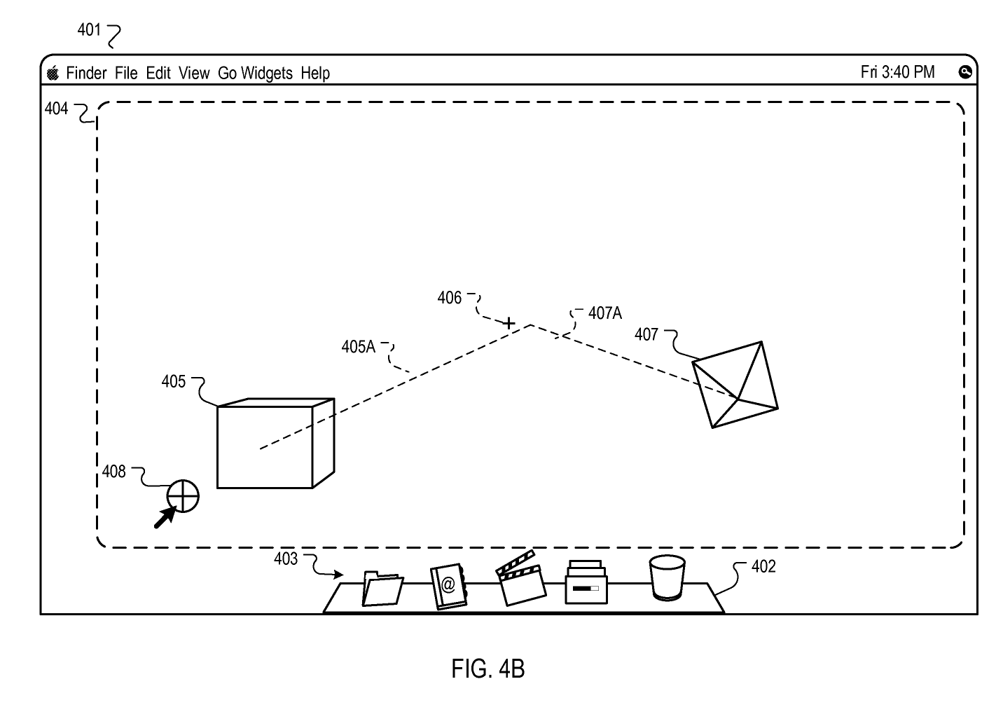

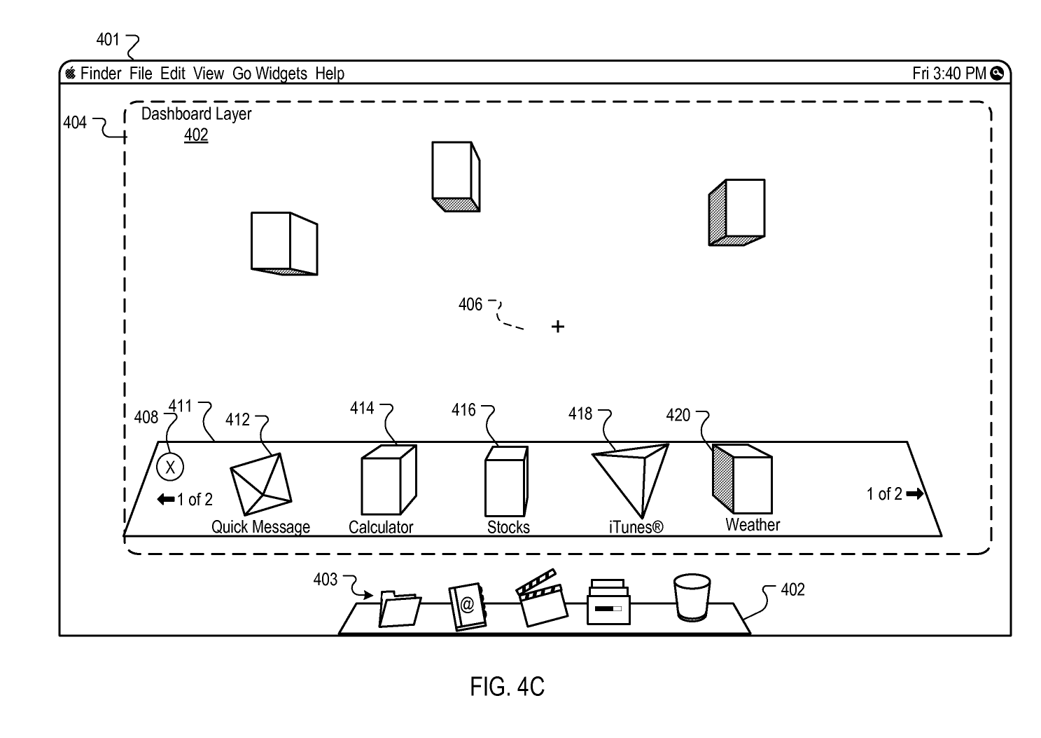

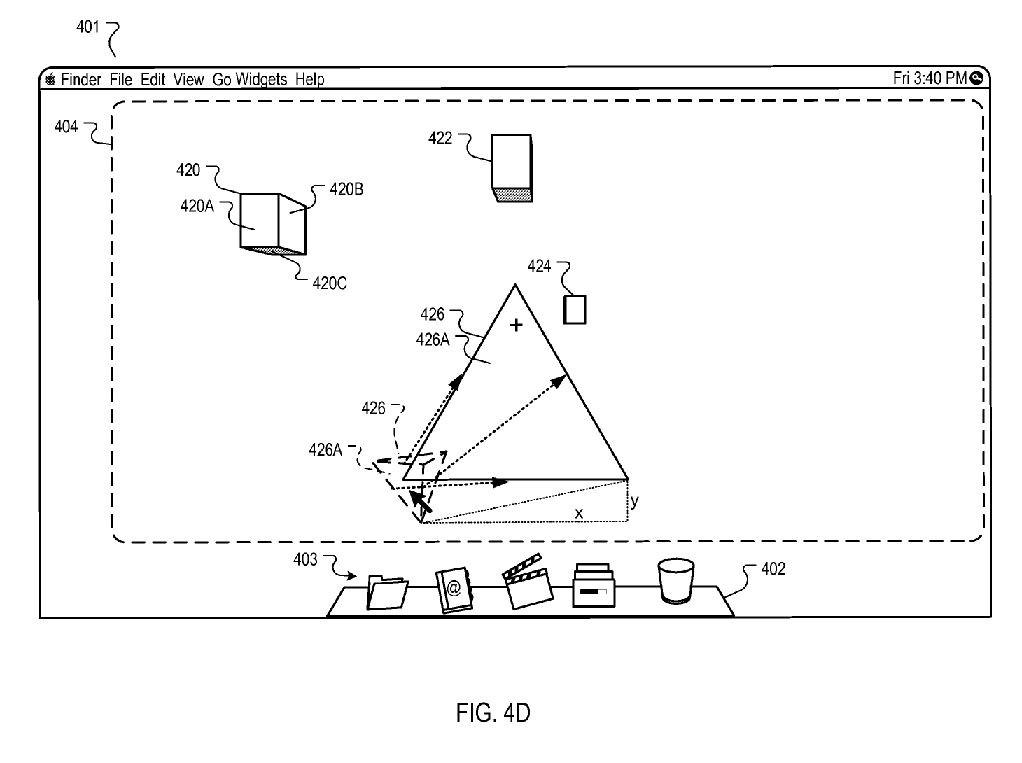

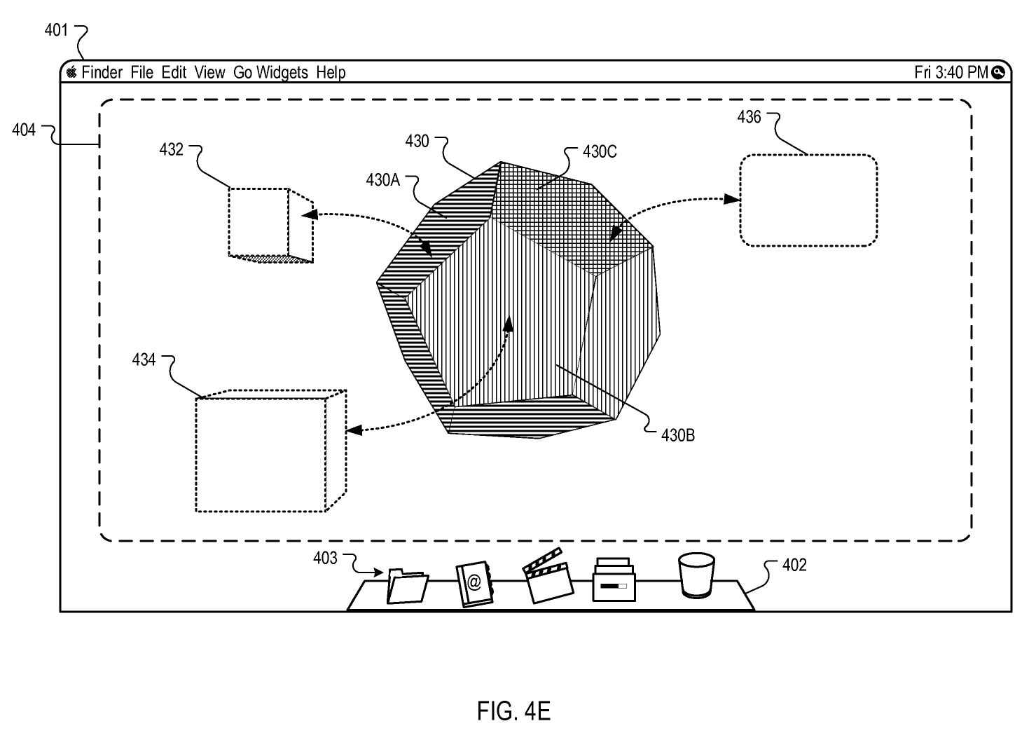

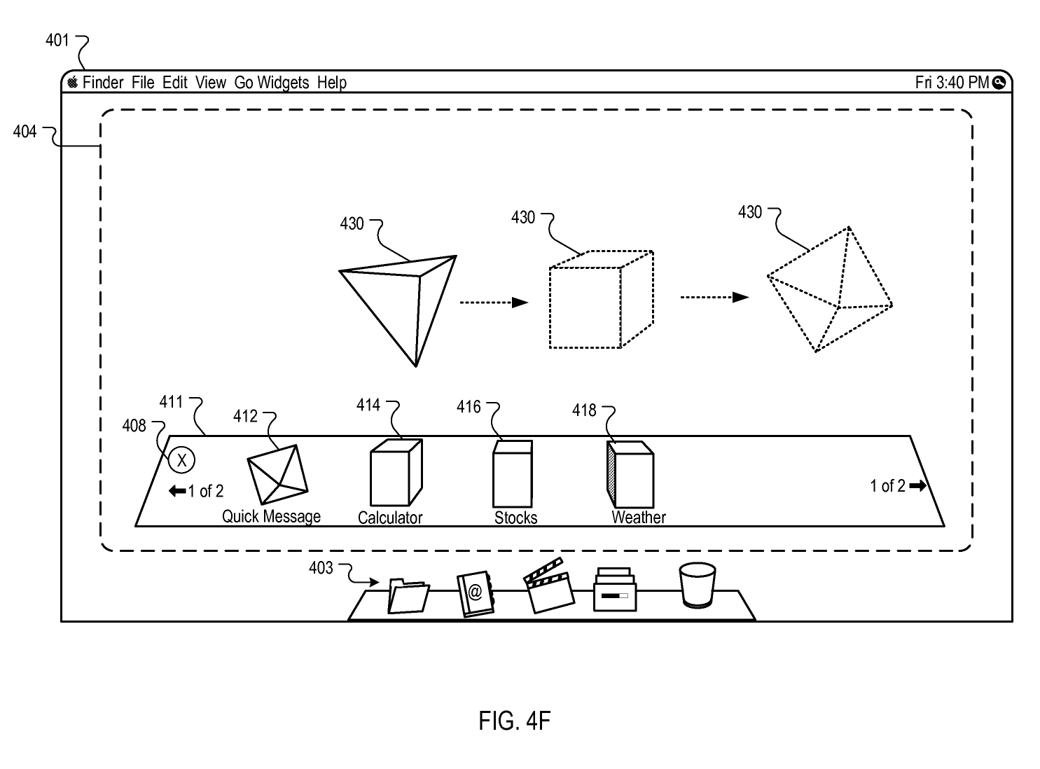

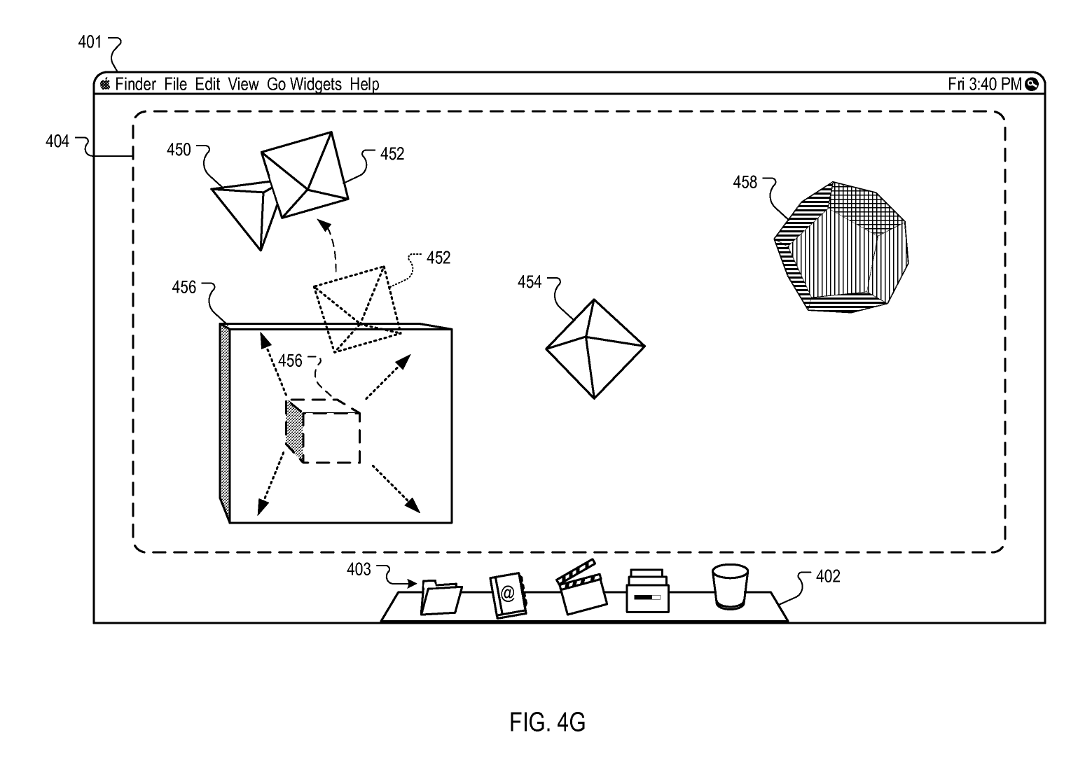

FIG. 4A depicts a desktop user interface 400 prior to activation of a dashboard. The desktop user interface 400 (also referred to herein as “desktop”) is a user interface as may be provided by an operating system, such as Mac OS®. The desktop 400 has a background image that defines a back surface on the z-axis, such as a uniform desktop color or an image, a menu bar 401, and other standard features, such as an example icon receptacle 402 and one or more icons 403. The icon receptacle 402 can include x-, y- and z-axis aspects, e.g., a height, width and depth.

The desktop 400 may also include windows, icons, and other elements (not shown). The user activates the dashboard by selecting an item from a menu, or by clicking on an icon, or by pressing a function key or key combination, or by some other means for invoking activation. A dashboard does not have to be activated on a desktop; rather the dashboard can be activated and displayed in any three-dimensional environment with or without a desktop.

FIG. 4B depicts an initial state for a dashboard layer 404. In some implementations, a configuration bar icon 403 is initially displayed. Alternatively, upon activation the dashboard layer 404 can display one or more default three-dimensional widgets 405 and 407. If the dashboard layer 404 has previously been activated and configured, the widgets 405 and 407, can be displayed as previously configured. In some implementations, the three dimensional widgets 405 and 407 are rendered relative to a perspective point 406. The perspective point 406 can be located anywhere within (or without) the dashboard layer 404 in three-dimensional space.

The dashboard layer 404 is not necessarily visible as a visible layer. However, its various components (such as widgets, icons, and other features) are visible. In some implementations, these components are displayed in a transparent layer, thus maintaining the visibility of the desktop 400 to the user. In some implementations, the desktop 400 and its components are darkened (or blurred, or otherwise visually modified) while the dashboard layer 404 is active, so as to emphasize that the desktop 400 is temporarily inactive. In other implementations, the desktop 400 is not visible while the dashboard layer 404 is active. The user can reactivate the desktop 400 and dismiss the dashboard layer 404 by, for example, selecting on an area of the screen where no dashboard element is displayed (i.e., “negative space”). In some implementations, other commands, key combinations, icons, or other user input can be used to dismiss the dashboard layer 404.

The dashboard layer 404 defines a viewing surface, i.e., a camera surface, that is position relative to the desktop surface along a depth axis, i.e., the z-axis. The three-dimensional widgets 405 and 407 can be positioned anywhere along the depth axis, as will be described with respect to FIGS. 4C-4G. As depicted in FIG. 4B, the depth axis is normally disposed from the dashboard surface 404, as indicated by the point 406, which is a normal perspective of the depth axis such that the axis appears as a conceptual point, and the three-dimensional widgets 405 and 407 are rendered with a perspective relative to the point 406, as indicated by perspective lines 405A and 407A. The point 406 and perspective lines 405A and 407A are normally not visible, and are shown for illustrative purposes only.

In some implementations, the user can drag an icon 408 to any location on the screen, and the position of the icon 408 will remain persistent from one invocation of the dashboard layer 404 to the next. The user can click on the icon 410 to activate the configuration bar 411, as shown in FIG. 4C. The configuration bar 411 provides access to various widgets, including three-dimensional widgets 412, 414, 416, 418 and 420 that can be placed on the layer 404. In some implementations, a text label is shown for each available widget (e.g., calculator, stocks, iTunes®, etc.). If many widgets are available, the widgets may be arranged hierarchically by type (e.g., game widgets, utility widgets, etc.), or alphabetically, or by any other categorization methodology. For example, a number of categories may be displayed, and clicking on one of the categories causes a pull-down menu to be displayed, listing a number of widgets in that category.

Note that the particular configuration and appearance of configuration bar 411 in FIG. 4C is merely exemplary, and that many other arrangements are possible. For example, widgets can be installed from other locations, other applications or other environments, without requiring that they first be part of the configuration bar 411. The user can dismiss the configuration bar 411 by clicking on dismissal button or icon 409, or by inputting a corresponding keyboard command.

### Installation of Elements

Elements, including user interface elements such as widgets, can be installed in a display environment as discussed below. For three-dimensional widgets, the display environment is defined by a viewing surface, i.e., a modeled camera surface, and a back surface disposed from the viewing surface along a depth axis. In some implementations, the viewing surface and the back surface can be visible, e.g., a translucent viewing surface and an opaque back surface. In other implementations, one or both of the viewing surfaces and the back surfaces can be invisible. In still other implementations, only a depth axis can be modeled extending from the viewing surface, and no back surface is modeled, i.e., the depth axis terminates at a vanishing point.

One display environment, a dashboard layer 404, will be used for illustrative purposes. Installation can include a preview operation as is discussed below. Installation can include selection of the element, such as by a drag and drop action. Other selection means can be used. In one example, a user can drag widgets from configuration bar 411 onto the surface of the dashboard (in other words, anywhere on the screen), using standard drag-and-drop functionality for moving objects on a screen.

In some implementations, three-dimensional widgets in the configuration bar 411 are smaller than their actual size when installed. When the user clicks on a widget and begins to drag it into a dashboard or other display environment, the widget can be animated to its actual or installed size to assist the user in the real-time layout of the dashboard. By animating the widget to its actual size, the user will know the actual size of the widget prior to its installation.

In some implementations, an animation according to a physics model, such as bouncing and inertia effects of the three-dimensional object of the widget, is shown when the user “drops” a widget by releasing a mouse button (or equivalent input device) to place a widget at the desired location.

In one implementation, the dragging of the widget to the dashboard layer 404 invokes an installation process for installing the widget including previewing. After installation, the user can move a widget, to any other desired location, or can remove the widget from the screen, for example by dragging it off the screen, or dragging it back onto the configuration bar 411, by invoking a remove command, disabling a widget in a menu associated with a widget manager or canceling the installation during the preview. In some implementations, the position, state, and configuration of a widget are preserved when the dashboard layer 404 is dismissed, so that these characteristics are restored the next time the dashboard layer 404 is activated.

In some implementations, widgets and/or dashboard layers (including widgets) can be installed from within a running application. For example, a widget and/or dashboard (including widgets) can be an attachment to an email. When the user clicks the attachment, an installation process is invoked for the widget and/or dashboard which can also include a preview.

Widgets can be created or instantiated using an installer process. The installer process can include a separate user interface or an integrated user interface (e.g., integrated in the display environment or separate from the display environment, for example, in another display environment associated with another application, such as an email application) for selecting and installing widgets in a display environment. For example, a widget received as an email attachment can be launched by a user from directly within a user interface of the email application.

In general, an installer process is used to provide additional functionality to the creation/instantiation process, beyond the simple drag and drop operation describe above. Additional functionality can include preview, security and deletion functionality in a singular interface. The installer process can be a separate process or combined in another process. The installer process can itself be a separate application that is executable to install widgets (or other elements) in a display environment. As used herein, the term “process” refers to a combination of functions that can be implemented in hardware, software, firmware or the like.

### Three-Dimensional Widget Manipulation and Function

FIG. 4D is a screen shot depicting an example display of three-dimensional widgets in a dashboard. Four widgets 420, 422, 424 and 426 are displayed. Each of the three-dimensional widgets is a three-dimensional representation of an object (e.g., a three-dimensional polyhedron). As initially displayed, the widgets 420, 422, 424 and 426 are rendered from a central perspective and positioned along the depth axis. Each of the widgets 420, 422, 424 and 426 has application surfaces that are associated with a widget function of the three-dimensional widget.

Each widget can be selected by a user, such as by use of cursor, and rotate and/or moved in the three modeled dimensions. Various interaction models can be used to manipulate the widgets. For example, mousing over a widget and holding down a right click button when the cursor is on an application surface can allow the user to select the widget to position the widget in the x and y-dimensions, while holding down a left click button can allow the user to position the widget along the z-axis. To rotate a widget, the user can mouse over a cursor and use a mouse wheel, which imparts a rotation about an axis defined by the position of the cursor relative to a centroid of the rendered object represented by the widget.

Double clicking on an application surface can instantiate a widget to realize a corresponding widget function associated with the application surface. For example, widget 420 has three application surfaces 420A-420C shown, and the widget can be rotated to show the remaining three application surfaces. The widget 420 may thus have up to six functions associated with the six application surfaces.

The functions associated with each application surface can be selected by the user, or can be predetermined. For example, if the widget 420 is a stock widget, the application surface 420A can implement the function of showing industrial averages for several markets. Each remaining application surface can provide the function of stock quotes and technicals (price to earnings ratio, volume, etc.) of a stock specified by a user.

In some implementations, the three-dimensional widget can change polyhedron types to provide more application surfaces as more functions are specified by a user. For example, a three-dimensional widget with four or fewer functions can be of the form of a tetrahedron; a three-dimensional widget with five or six functions can be of the form of a hexahedron; a three-dimensional widget with seven or eight functions can be of the form of a octahedron; and a three-dimensional widget with nine functions can be of the form of a dodecahedron. Thus, if a user specifies ten stock tickers for quotes and technicals, the widget 420 can expand from a hexahedron to a dodecahedron.

In some implementations, a three-dimensional widget rotates to present an application surface when an activation surface is actuated. For example, the widget 426 is initially disposed as indicated by the dashed rendering. The application surface 426A is selected by use of a mouse over and a double click operation. In response, the widget 426 rotates as indicated by the transitional edge arrows so that the application surface 426A is parallel to the plane defined by the dashboard layer 404, and an application environment to realize the widget function is presented in the area of the application surface 426A. The widget 426 can optionally move toward the center of the dashboard layer 404 as well, as indicated by a selection offset x and y. Upon deselection, the widget 426 can return to its initial location indicated by the dashed rendering 426.

In some implementations, each three-dimensional widget is disposed at a first depth along the depth axis when the three-dimensional widget is selected and is disposed at a second depth along the depth axis when the three-dimensional widget is not selected. The first depth is less than the second depth relative to the viewing surface. For example, the widget 424, before being selected, is disposed at the second depth, i.e., at a negative distance on the z-axis if the viewing surface is at the origin of the z-axis. Upon selection, however, the widget 424, during the rotational operation, moves up the z-axis so that the application surface 424A is at the viewing surface or just below the viewing surface.

In some implementations, for each three-dimensional widget the second depth can be proportional to a frequency at which the three-dimensional widget is selected relative to other three-dimensional widgets. For example, in FIG. 4D, the widgets 420, 422 and 426 each have a second depth that is substantially the same, indicated that these widgets are selected at substantially the same rate as each other. However, with widget 424 has a second depth that is deeper than the second depth of the widgets 420, 422 and 426, indicating that this widget is selected less often than the other widgets. In some implementations, the widget 424 can be removed by vanishing into a “vanishing point” if it is not selected. In other implementations, the second depth can have a minimum value after which the second depth can not be decreased. In variations of these implementations, the widget 424 can be removed from the dashboard layer 404 if it is not selected.

In some implementations, widgets can be grouped into a widget receptacle. FIG. 4E is a screen shot depicting the grouping of two three-dimensional widgets 432 and 434 and conventional widget 436 to generate a widget receptacle. The widget receptacle 430 can be disposed along the depth axis and have receptacle surfaces that are each associated with a widget actuated by a selection of the receptacle surface. Upon such selection, the widget associated with the receptacle surface is instantiated.

For example, the widgets 432 and 434 can be grouped, e.g., both selected and grouped by a keyboard command and/or mouse function, and the widget receptacle 430 is generated in response to the grouping. In some implementations, only one receptacle surface is associated with a widget. For example, the surface 430A is associated with the widget 432; the surface 430B is associated with the widget 434; and the surface 430C is associated with the widget 436. Accordingly, the widget receptacle 430, which in this example is a dodecahedron, can be associated with twelve widgets. Upon selection of a receptacle surface, such as the surface 430A, the associated widget 432 is instantiated in the dashboard layer 404, as indicated by the double arrow linking the widget 432 and the receptacle surface 430A.

In other implementations, the application surfaces associated with corresponding widget functions of the three-dimensional widget are associated with the receptacle surfaces. For example, the widget 432 has at least three applications surfaces with which a corresponding function is associated, as indicated by the three receptacle surfaces with the shaded pattern of the receptacle surface 430A. Likewise, the widget 434 has at least two applications surfaces with which a corresponding function is associated, as indicated by the two receptacle surfaces with the shaded pattern of the receptacle surface 430B. Finally, the conventional widget 436 is associated with the receptacle surface 430C.

In response to a selection of one of the receptacle surfaces associated with a widget function, the three-dimensional widget for which the widget function is associated is instantiated to realize the corresponding widget function. For example, if the receptacle surface 434B is a stock quote for a certain stock, then selection of the surface 434B can instantiate the widget 434 in a manner that the stock quote function for the certain stock is performed. In some implementations, the widget 434 is instantiated as a separate widget from the widget receptacle 430 as indicated by the double arrow linking the widget 434 and the receptacle surface 430B. In other implementations, the widget 434 can be instantiated from within the widget receptacle 430, i.e., the receptacle surface is used as the application surface for the associated widget 434, and the widget 434 is not rendered as a separate widget from the widget receptacle.

In some implementations, only widgets belonging to a same category can be grouped into a widget receptacle. For example, only financial widgets can be grouped into a financial widget receptacle, and other widgets not belonging to the financial category, e.g., a weather widget, cannot be added to the widget receptacle. In other implementations, any widgets selected by a user for grouping can be grouped into a widget receptacle. The widget receptacle can be persisted as a widget grouping 307.

In some implementations, the receptacle surfaces can have a visual indicator to indicate receptacle surfaces associated with a widget. For example, if two widgets are used to form a widget receptacle, then the receptacle surfaces associated with the first widget can have a first background color, and the receptacle surfaces associated with the second widget can have a second background color.

FIG. 4F is a screen shot depicting various widget receptacles in response to configuring three-dimensional widgets using the configuration bar. Widgets 412, 414, 416 and 418 can be grouped to form the widget receptacle 430. In some implementations, the widget receptacle 430 is a three-dimensional polyhedron that is selected to provide the minimum number of surfaces for association with all applications surfaces that have associated functions. As shown, the widget receptacle 430 may initially be a tetrahedron if two widgets that have a total number of application surfaces of four or less are grouped. As additional widgets are grouped, the widget receptacle can expand to a hexahedron or an octahedron. For example, referring again to FIG. 4E, as the widget receptacle 430 is a dodecahedron, the total number of associated application surfaces associated with functions of the widgets 432, 434 and 436 is at least eight, and no more than twelve.

Although the widgets and the widget receptacles of FIGS. 4B-4F have been illustrated with a central perspective point, the widgets and widget receptacles can be rendered without such perspective in three dimensional space. FIG. 4G is a screen shot depicting three-dimensional widgets 450, 452, 454 and 456 and a widget receptacle 458 displayed along a depth axis without a perspective angle.

As illustrated by the widget 456, the selection of a widget can cause the widget to transition from the second display depth to the first display depth. In the implementation shown, an x and y offset toward the center of the dashboard layer 404 is not implemented. Also, upon the transition of the widget 456, the widget expands into an x, y, z-coordinate or space occupied by the widget 454. The widget 454, in turn, is displaced according to a Newtonian physics model. Additional interactions between other widgets could also be modeled, such as the widget 450 being slightly displayed as well in response to contact with the widget 452.

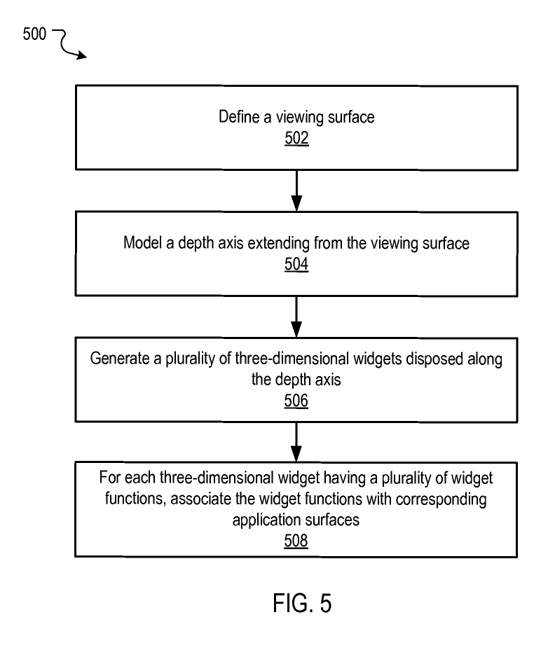

FIG. 5 is a flow diagram of a process 500 for generating and displaying three-dimensional widgets. The process 500 can, for example, be implemented using the software architecture 300 of FIG. 3 and the computer system 100 of FIG. 1.

A viewing surface is defined (502). For example, a dashboard layer can define the viewing surface, or some other surface defined by the x-y plane at a coordinate on the z-axis.

A depth axis is modeled that extends from the viewing surface (504). For example, the z-axis can be modeled to have negative coordinates relative to the viewing surface.

Three-dimensional widgets are generated and disposed along the depth axis (506). For example, three-dimensional widgets can be rendered as described in FIGS. 4B-4G above. Different first and second depths can be used, and different initial perspective angles, if any, can be used.

Each three dimensional widget has a corresponding application surface associated with a corresponding widget function (508). For example, a widget with five functions, such as weather widget with a first function of providing local weather conditions and four additional functions of providing weather conditions in four other cities, can have five of six surfaces of a hexahedron associated with the functions.

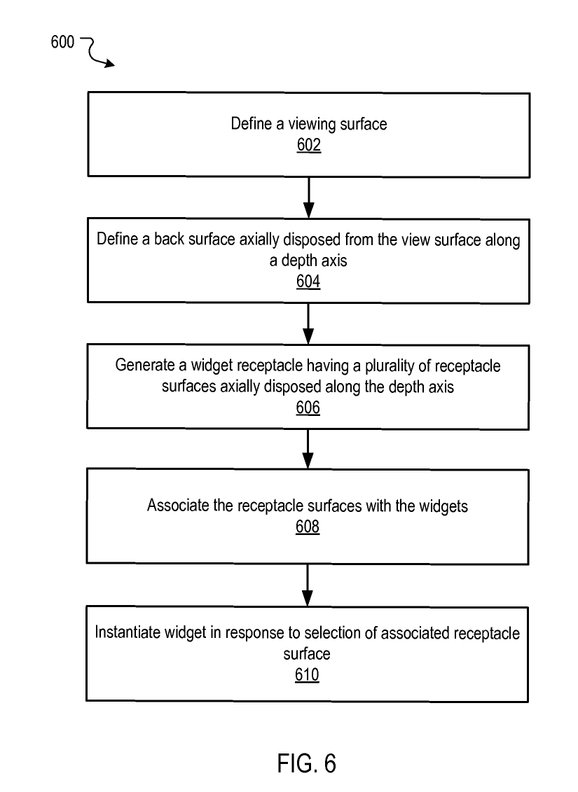

FIG. 6 is a flow diagram of a process for generating and displaying a widget receptacle. The process 500 can, for example, be implemented using the software architecture 300 of FIG. 3 and the computer system 100 of FIG. 1.

A viewing surface is defined (602). For example, a dashboard layer can define the viewing surface, or some other surface defined by the x-y plane at a coordinate on the z-axis.

A back surface is disposed from the view surface along the depth axis (604). For example, a back surface, such as an invisible plan above the desktop, can be positioned at a coordinate on the z-axis that is negative relative to the z-axis coordinate of the x-y plane.

A widget receptacle having receptacle surfaces and disposed along the depth axis is generated (606). For example, a three-dimensional polyhedron can be generated in response to the grouping of two widgets.

Receptacle surfaces are associated with the widgets (608). For example, in some implementations, only one widget can be associated with a corresponding receptacle surface. Thus, a hexahedron can be associated with up to six widgets.

In other implementations, each application surface of grouped widgets is associated with a corresponding receptacle widget. Thus, a hexahedron can be associated with up to six functions of a group of two or more widgets.

A widget is instantiated in response to a selection of an associated receptacle surface (610). For example, a widget that is associated with a receptacle surface can be generated in response to a selection of the receptacle surface. The widget can then be manipulated by the user to select a corresponding function from an application surface.

In other implementations in which each application surface of the grouped widgets is associated with a corresponding receptacle widget, a widget can be instantiated from within the widget receptacle, i.e., the receptacle surface is used as the application surface for the associated widget, and the widget is not rendered as a separate widget from the widget receptacle. Alternatively, the widget can be rendered separately from the widget receptacle and instantiated with the application surface selected.

It will be understood by those skilled in the relevant art that the above-described implementations are merely exemplary, and many changes can be made without departing from the true spirit and scope of the present invention. Therefore, it is intended by the appended claims to cover all such changes and modifications that come within the true spirit and scope of this invention.

What is claimed is:

1. A graphical user interface, comprising:
a viewing surface;
a modeled depth axis extending from the viewing surface; and
a plurality of three-dimensional widgets disposed along the depth axis, each three-dimensional widget being a three-dimensional representation of an object and having a plurality of application surfaces, each application surface for association with a widget function of the three-dimensional widget.

2. The graphical user interface of claim 1, wherein each three-dimensional widget is disposed at a first depth along the depth axis when the three-dimensional widget is selected and is disposed at a second depth along the depth axis when the three-dimensional widget is not selected, the first depth being less than the second depth relative to the viewing surface.

3. The graphical user interface of claim 2, wherein for each three-dimensional widget the second depth is proportional to a frequency at which the three-dimensional widget is selected relative to other three-dimensional widgets.

4. The graphical user interface of claim 1, further comprising a widget receptacle disposed along the depth axis, the widget receptacle being generated in response to a first three-dimensional widget being grouped with a second three-dimensional widget, and having widget surfaces that are associated with the first and second three-dimensional widgets.

5. The graphical user interface of claim 4, wherein each receptacle surface is associated with a corresponding widget function of a three-dimensional widget, and the three-dimensional widget is instantiated to realize the corresponding widget function in response to a selection of the receptacle surface.

6. The graphical user interface of claim 4, wherein each receptacle surface is associated with a corresponding three-dimensional widget and the corresponding three-dimensional widget is instantiated in response to a selection of the receptacle surface.

7. The graphical user interface of claim 1, further comprising widget receptacle disposed along the depth axis, the widget receptacle being associated with a widget category, and generated in response to two or more three-dimensional widgets associated with the widget category of the widget receptacle being grouped.

8. A graphical user interface, comprising:
a viewing surface;
a back surface disposed from the viewing surface along a depth axis; and
a widget receptacle disposed along the depth axis, the widget receptacle having a plurality of receptacle surfaces, each receptacle surface for being associated with a widget and actuated by a selection of the receptacle surface, and upon such actuation causing an instantiation of the widget associated with the receptacle surface.

9. The graphical user interface of claim 8, wherein a widget associated with a receptacle surface is a three-dimensional widget being a three-dimensional representation of an object and having a plurality of application surfaces associated with corresponding widget functions of the three-dimensional widget, and upon instantiation the three-dimensional widget is disposed along the depth axis.

10. The graphical user interface of claim 8, wherein the widget receptacle is generated in response to a first three-dimensional widget being grouped with a second three-dimensional widget.

11. The graphical user interface of claim 10, wherein each receptacle surface is associated with one of the widget functions of either the first three dimensional widget or the second three-dimensional widget.

12. The graphical user interface of claim 11, wherein in response to a selection of one of the receptacle surfaces associated with a widget function, the three-dimensional widget for which the widget function is associated is instantiated to realize the corresponding widget function.

13. A computer-implemented method, comprising:
defining a viewing surface;
defining a back surface disposed from the viewing surface along a depth axis; and
generating a plurality of three-dimensional widgets disposed along the depth axis, each three dimensional widget being a three-dimensional representation of an object and having a plurality of application surfaces; and
for each three-dimensional widget having a plurality of widget functions, associate the widget functions with corresponding application surfaces.

14. The method of claim 13, wherein generating a plurality of three-dimensional widgets comprises:
disposing a three-dimensional widget at a first depth along the depth axis in response to the three-dimensional widget being selected; and
disposing the three-dimensional widget at a second depth along the depth axis in response to the three-dimensional widget being deselected, the first depth being less than the second depth relative to the viewing surface.

15. The method of claim 14, further comprising:
determining a frequency at which the three-dimensional widget is selected relative to other three-dimensional widgets of the plurality of three-dimensional widgets; and
setting the second depth proportional to the frequency.

16. The method of claim 13, further comprising:
generating a widget receptacle disposed along the depth axis in response to a first three-dimensional widget being grouped with a second three-dimensional widget;
generating a first receptacle surface on the widget receptacle associated with the first three-dimensional widget; and
generating a second receptacle surface on the widget receptacle associated with the second three-dimensional widget.

17. The method of claim 16, wherein:
generating a first receptacle surface on the widget receptacle associated with the first three-dimensional widget comprises generating a corresponding receptacle surface for each application surface of the first three dimensional widget;
generating a second receptacle surface on the widget receptacle associated with the second three-dimensional widget comprises generating a corresponding receptacle surface for each application surface of the second three dimensional widget; and
further comprising instantiating one of the first or second three-dimensional widgets in response to a selection of a receptacle surface to realize the widget function associated with the application surface that is associated with the selected receptacle surface.

18. The method of claim 16, further comprising instantiating one of the first or second three-dimensional widgets in response to a selection of an associated receptacle surface.

19. The method of claim 16, further comprising:
associating the widget receptacle with a widget category; and
wherein generating the widget receptacle comprises generating the widget receptacle only if the first three-dimensional widget and the second three-dimensional widget belong to the widget category.

20. Software stored in a computer readable medium and comprising instructions executable by a computer system that upon such execution cause the computer system to perform operations comprising:
defining a viewing surface;
defining a back surface disposed from the viewing surface along a depth axis;
generating a plurality of three-dimensional widgets disposed along the depth axis, each three dimensional widget being a three-dimensional representation of an object and having a plurality of application surfaces; and
for each three-dimensional widget having a plurality of widget functions, associating the widget functions with corresponding application surfaces.

21. Software stored in a computer readable medium and comprising instructions executable by a computer system that upon such execution cause the computer system to perform operations comprising:
defining a viewing surface;
defining a back surface disposed from the viewing surface along a depth axis; and
generating a widget receptacle disposed along the depth axis, the widget receptacle and having a plurality of receptacle surfaces, each receptacle surface being associated with a widget and being actuated by a selection of the receptacle surface, and upon such actuation causing an instantiation of the widget associated with the receptacle surface.
